(19) United States
(12) Patent Application Publication
(10) Pub. No.: US 2008/0197675 A1
(43) Pub. Date: Aug. 21, 2008

(54) Seal for a Glass Roof with at Least Two Glass Covers

(76) Inventor: Dennis Rinse Nolles, Munchen (DE)

Correspondence Address: DICKINSON WRIGHT PLLC, 1901 L. STREET NW, SUITE 800, WASHINGTON, DC, 20036, US

(21) Appl. No.: 11/912,994

(22) PCT Filed: Apr. 25, 2006
(86) PCT No.: PCT/DE2006/000732

§ 371 Date: Oct. 29, 2007

(30) Foreign Application Priority Data
Apr. 29, 2005 (DE) 20 2005 006 879.9

(51) Int. Cl. B60J 10/02; B62D 25/00; E06B 3/64

(52) U.S. Cl. 296/215; 52/787.12; 52/209

(57) ABSTRACT

Glass roof (1) with at least two glass covers (2, 3), the glass covers (2, 3) being formed with impact edges (6, 27) facing each other and there being a formed-on part (4) along a impact edge (6) on one glass cover (2), the formed-on part (4) extending away from the impact edge (6) below the glass cover (2) and, in order to seal the impact region between the two glass covers (2, 3), the formed-on part (4) accommodating a seal (16) adjacent to the impact edge (6), the seal (16) extending from an upper side wall (10) of the formation (4) in the direction of a lower side of the glass cover and, on the upper side, forming a supporting wall (21) for the second glass cover (3) and, in addition, there is at least one support (35) for the second glass cover (3) and the seal (16), with the supporting wall (21) cut free from the sealing body, rests on the support (35) in such a manner that an intermediate layer is formed between the second glass cover (3) and the support (35).

The invention relates to a glass roof with at least two glass covers.

US 2003/0127884 A1 discloses a sunroof assembly. This arrangement is intended to overcome a disadvantage to the effect that, in generally known sunroof assemblies, a seal acts as the sealing component between a first movable panel and a second movable panel, and which is positioned behind the first movable panel in the direction of motion. A drawback in this type of sunroof assembly is that these sorts of conventional seals, which span the gap between both panels, are not resistant to water pressure, so that when the motor vehicle is being washed, especially with high water pressure, water invades the vehicle compartment.

To solve this problem, US 2003/0127884 A1 proposed (FIG. 4) forming a retainer 101 on one of the panels 100. The retainer extends away from a impact edge 102 that runs transverse below the plane of the glass panel of the impact edge, by means of which a plate-like support 103 is formed below the second movable panel 104 whenever the panels 100, 104 bump against each other. A seal 105 is applied to this support 103 that runs transverse to the impact edge, and is formed out of two hollow sealing beads 106, 107 spaced apart from each other. Thus, a sealing bead is placed adjacent to the above-mentioned impact edge 102; the second sealing bead 107, in the roof top's closed state, is placed beneath the second movable glass panel 104. In addition, the second movable glass panel 104 has a liner 108 that runs transversely, and which is formed on this panel. This transversely running liner additionally lies flat on a sealing strip 109 or sealing lip 109, which protrudes from the second sealing bead 107. In this way, when closed, the second movable panel 104 rests indirectly over the seal 105 with the two sealing beads 106, 107 on the retainer 101 of the first movable panel. A drawback in such an arrangement is that the second movable panel is movable vertically relative to the first movable panel, since the sealing beads 106, 107 can be compressed by the second movable panel 104. This means that a vertically aligned arrangement of the panels to each other is difficult, and that the second panel swings on the first panel. Furthermore there is no assurance that the seal will provide a reliable seal against water and noise for all tolerances (warping tolerances of both glass panels).

To improve the alignment of the glass panels relative to each other, a known procedure involves forming a support on the retainer, which, in the closed state, is positioned under one of the movable panels and fastened to the other panel. This support is formed out of foamed material, especially polyurethane foam, and bumps against the glass from below. A drawback in this case is that layers applied to the lower side of the glass must be removed, since otherwise they would be abraded by the polyurethane foam. These layers are, for example, ceramic layers—so-called frits—which are printed onto the glass using the screen printing method, and are designed to prevent light from leaking into the region of the seals to avoid deterioration of the seal.

However, this also means that the support is visible through the glass from the outside. Moreover, noises are produced as the result of direct contact between the polyurethane foam on the glass. Therefore, additional damping or friction elements, in particular made of Teflon, are required. This requires a significant increase in assembly work, as well as higher logistics costs due to additional expenditure in obtaining and purchasing materials, etc.

The object of this invention is to improve the alignment of the movable panels or covers of a glass roof with at least two glass covers, to increase seal tightness, and to substantially reduce assembly and logistics costs.

The object is attained by the characteristics of claim 1.

Advantageous further developments are identified in the sub-claims.

The object set by the invention is to implement the support and adjustment of the covers in relation to each other, the so-called scaling setting, in the peripheral regions of the covers or panels or centered (already in the water-bearing region) on the polyurethane sprayed foam or foam cladding. An intermediate layer made of rubber is to be placed between the polyurethane foam cladding support formed in this way, and the glass cover that rests on top of it. For this purpose, an existing rubber seal already provided, which seals the impact area between the two panels or covers from below, will be pulled out over the foam sprayed support, whereby, in certain areas, the rubber seal will be cut free. By means of a conventional hollow-chamber seal, seal tightness is thus ensured between two supports, which are arranged in the lateral regions. In order to further improve tightness, and in particular to ensure sealing with all tolerances (camber tolerances of the two covers), a nose is formed in the area of the impact edge on the underside of the movable panel supported by the seal and is supported by the seal.

An advantage provided by the invention is that it provides a simple, cost-effective, and reliable seal with minimal assembly expenditures, as well as providing a dependable scaling setting, whereby the supports are not visible as a distinct components, which might disturb the over-all impression.

The invention is explained through a drawing. Shown are:

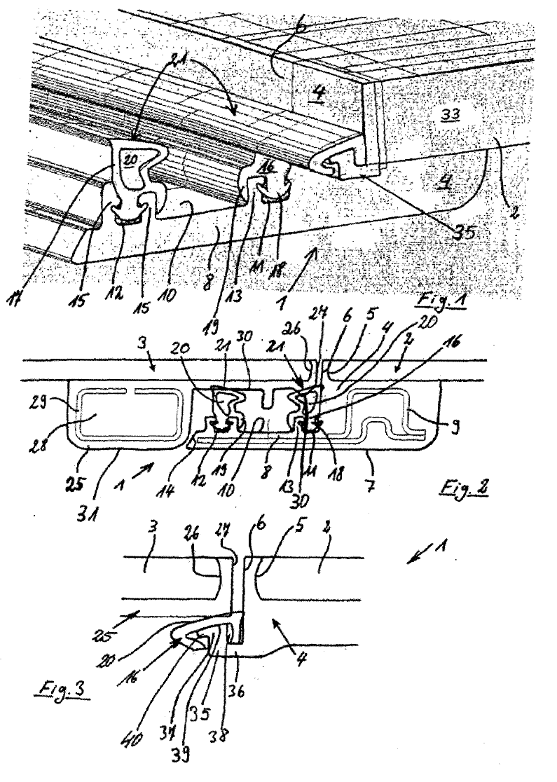

FIG. 1: Impact area between two glass panels or glass covers of a glass roof in a perspective lateral view;

FIG. 2: the impact area according to FIG. 1 in a strongly schematic and laterally cut view;

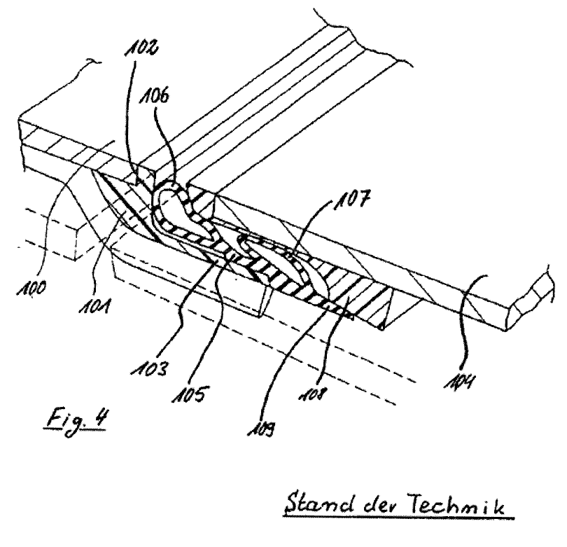

FIG. 3: the impact area according to FIG. 1 in the area of the support;

FIG. 4: the construction of a sunroof in the impact area according to the state of the art.

A glass roof according to the invention 1 (FIGS. 1 to 3) has a first, in particular rear glass cover 2, and a second, in particular front glass cover 3.

The glass cover 2 is provided with foam cladding 4, which extends at least along a first, transversal edge 5 of the glass panel or of the glass cover 2, and which runs transversely to the vehicle's longitudinal direction. Such foam cladding 4 is known, and may be located along the transverse, but also along the longitudinal edge of a glass cover, and normally accommodate functional items, such as guide rails. The foam cladding 4 and the glass cover 2 are formed in one piece and at a short distance from the transverse edge 5 of the glass cover 2, the foam cladding 4 forms a parallel impact edge 6 of the combination of foam cladding 4 and glass cover 2.

Underneath the region along transverse edge 5 of glass cover 2 or parallel-running impact edge 6, the foam cladding 4 of glass a panel 2 extends downward, strip-like, in line with impact edge 6. Aligned with a base wall 7 of the foam cladding 4, essentially parallel to the panel plane, an integrally formed, substantially plate-like gutter 8 extends away from the strip-like foam cladding 4 or the impact edge 6, essentially parallel to the plate plane of the glass cover 2. The gutter 8 and the foam cladding 4 are formed out of one piece, whereby to stabilize the foam cladding 4 and the gutter 8, a one-piece stabilizing support 9, in particular made of a metal plate, is incorporated into the foam.

Two seal receiving grooves 11 and 12 are located on an upper lateral wall 10 of the gutter 8 which is essentially designed to be parallel with the plate plane of the glass cover 2.

A first seal-receiving groove 11 extends along the impact edge 6, whereby a groove wall 13 rises from the impact edge 6, from the upper side wall 11 at a distance equal to the width of the seal groove 11. The groove wall 13 and the impact edge 6 thus delimit the seal receiving groove 11 between them. The second seal receiving groove 12 is provided adjoining an outer longitudinal edge 14 of the gutter 8 and is delimited by two rising walls 15 delimiting the groove 12. The groove walls 15, the groove wall 13 as well as the impact edge 3 are in this case parallel, and this means that the groove walls 13, 15 or the grooves 11, 12 extend transversally relative to a longitudinal vehicle axis. The actual area for receiving and removing entering water is formed between the grooves 11, 12.

A seal 16, 17 is inserted into each of the grooves 11, 12. The seal 16 is a hollow-chamber seal extending with a fastening area 18 into the groove 11. The fastening area 18 is designed in this case in the manner of a strip that matches the groove and is preferably provided with a contour, e.g. a contour that is arrow-shaped in its cross-section, in order to oppose the pulling out of the seal 16 from the seal receiving groove 11.

In addition the seal 16 is provided with a sealing strip 19 extending across and over the groove wall 13 and pressing against the side of the wall 13 across from the seal receiving groove 11, said sealing strip 19 extending up to the upper lateral wall 10 of the gutter 8. Above the groove 11 the seal 16 widens away from the impact edge, whereby a hollow chamber 20 is formed in the seal above the seal receiving groove 11.

At the top the seal 16 terminates with a supporting wall 21 that extends at a slight slant and is slightly cambered and is on the one hand in contact with the impact edge 6 and, dropping off from the impact edge 6, points in the direction of the gutter 8. The supporting wall 21 width in this case reaches from the impact edge 6 to somewhat beyond the width of groove 11, including the groove delimiting wall 13. The seal 16 terminates at the impact edge 6 with the supporting wall 21 somewhat below a lower surface of the glass cover 2.

The second glass cover 3 is also provided with foam cladding 25. The foam cladding 25 constitutes an impact edge 27 in the area of a transversal edge 26 of the glass cover 3 at a small distance from this transversal edge 26 across from the impact edge 6 and parallel to the latter. The foam cladding 25 extends from this impact edge 27 under and along the glass covers 3 and, at a distance from the impact edge 27, constitutes a strip 28 extending parallel to the impact edge 27 with a cross-section in form of a right parallelepiped. To stabilize the foamed-on strip 28 a metal-sheet stabilizer 29 can also be provided and in particular can be imbedded in the foam. The distance from the impact edge 27 to the strip 28 is approximately equal to the distance from the impact edge 6 to the outer longitudinal edge 14 of the gutter, so that in a state in which the impact edge 27 is in contact with the impact edge 6, i.e. when the glass roof 1 is in a completely closed state, the transversally extending edge 14 presses against the strip 28.

In the lower area of the 27 in which the impact edge 37 turns into a surface 30 extending parallel to the glass roof 1, a nose 30 projecting downward over the surface 30 is formed on the foam cladding 25. The foam cladding 25 also consists of polymer foam, preferably polyurethane foam. In the closed state a lower surface 32 of the strip 28 preferably terminates with the lower surface 7 of the foam cladding 4.

In the border area along the longitudinal edges 33 of the glass cover 2 and of the glass cover 3, the foam claddings 4, 25 or the gutter 28 is cut free so that the glass covers 2, 3 can bridge guide rails (not shown) located on both sides below their longitudinal edges 33 and beneath these longitudinal-edge areas of a glass roof frame built into a vehicle. The gutter 8 extends therefore between these two guide rails or similar mechanism, while the glass covers 2, 3 cover these guide rails from above.

The guide rails and the gutter 8 act in this case together in such manner that water penetrating through the impact area between the impact edges 6 and 27 and entering the gutter 8 is diverted to the outside, into the area of the guide rails or similar mechanism.

In the area of the guide rails or in the area in which the glass cover 2 bridges or covers the guide rails and in which the gutter 8 is recessed, each of the foam claddings 4 constitutes a support 35. The support 35 extends in this case below the glass cover 2 away from the impact edge 6, whereby a base wall 36 is constituted and extends from the base wall 36 of a bearing strip 37 upward at an interval from the impact edge 6 and parallel to said impact edge 6.

A groove 38 extending parallel to the impact edge 6 is created by the interval between the bearing strip 37 and the impact edge 6. The bearing strip 37 terminates at the top with a bearing surface 39. The bearing surface 39 extends from the groove 38, is slightly cambered on top and drops away from the groove 38, constituting a nose 40 that protrudes over the bearing strip 37.

The support 35 is designed in this case so that the bearing surface 39 is placed so that it is in the area of the hollow sealing chamber 20 in such manner that the bearing surface 39 is located at the level of the inside of the seal support wall 21. In order to cover the support 35 on top, the seal 16 is recessed or cut out in the area of the hollow chamber 20 in such manner that only the support wall 21 as well as part of the seal wall pressing against the impact edge 6 remains.

The latter wall segment of the seal 16 is continued in the groove 38 while the seal supporting wall 21 lies on top on the bearing surface 39 of the support 35. This makes it possible for the seal 16 to bridge also the support 35, so that the seal 16 which seals off the impact area between the impact edge 27 and the impact edge 6 in the area of the gutter 8, serves at the same time as intermediate layer of the support 35.

Thanks to this continuous seal, especially good sealing action is achieved in the area of the gutter 8 as well as in the area of the supports 35 delimiting the gutter 8 laterally, because no gap is formed in the area of the gutter between an intermediate layer of the support 35 and the seal.

It is an additional advantage that no separate component has to be provided between the support 35 and the foam cladding 25 of the glass cover 3.

In the area of the support 35 or of the cut-out seal 16, the underside 30 of the foam cladding 25 and the impact edge 27 form essentially a 90° angle, so that a nose 30, not needed in the area of the support 35, is not formed in this area.

The seal 17 which is of the same design as the seal 16 but faces the seal 16 with its descending supporting wall 21, is located in the second groove 12. The seal 17 extends however only in the area of the gutter 8, and not laterally beyond the gutter 8.

The seal 16 or the seals 16, 17 can also be cemented on next to the gutter 8 or the impact edge 6, SO that separate grooves 11, 12 can be omitted.

It is an advantage of the invention that a gutter foamed on the glass cover and the supports needed to set the scaled settings are installed in one piece on a glass cover and are in particular foamed on to it, whereby the supports installed laterally next to the gutter are designed so that a seal for the sealing of the impact area between two glass covers is continued with an upper seal side over and beyond the gutter to the support, and thus serves for a double function as seal in the area of the gutter and intermediate layer of the support. As a result, assembly steps and thereby the cost of separate components and logistics can be saved.

By providing a nose on the underside acting upon the seal in the impact area between the two glass covers, it is also possible to achieve reliable sealing off of water and noise when the glass covers are tilted in relation to each other or with different tolerance positions regarding the camber tolerance of the two covers. The pressure between the component to be sealed, i.e. the glass cover, and the sealing bead is increased in a timely fashion, and the pressure is not reduced even when the tilting angles are different.

The invention is not limited to the installation of supports in the area of guide rails or other mechanisms of the sliding roof located under the supports. Such supports or such support system can be provided in addition in the area of the gutter, and can be produced easily by means of suitable foaming. Accordingly, the seal is suitably cut free in this area. One or several supports can be provided along the impact area of the impact edges of two glass covers. Such supports are of course not limited to impact areas extending transversally to the direction of the vehicle, but can obviously be provided in any impact area that is sealed off in a manner according to the invention.

Accordingly the invention is also not limited to the utilization of glass roofs but can be applied wherever two components that are movable relative to each other constitute a common impact area that must be sealed off, and whereby one component is to be supported by the other component.

### LIST OF REFERENCE NUMBERS

1 glass roof

2 first cover

3 second cover

4 foam cladding

5 transverse edge of 2

6 Impact edge of 2

7 base wall of 4

8 gutter

9 stabilizing support

10 upper side wall

11 seal-receiving groove

12 seal-receiving groove

13 groove wall

14 outer longitudinal edge

15 groove walls

16 seal

17 seal

18 fastening area

19 sealing strips

20 hollow chamber

21 supporting wall

22

23

24

25 foam cladding

26 transverse edge

27 impact edge

28 strip

29 stabilizer

30 underside surface

31 nose

32 bottom surface of the strip 28

33 longitudinal edge

34

35 support

36 base wall area

37 bearing strip

38 groove

39 bearing surface

40 nose

1. Glass roof (1) with at least two glass covers (2, 3), characterized in that
the glass covers (2, 3) are designed with impact edges (6, 27) pointing to each other
a formed-on part (4) is provided on a glass cover (2) along an impact edge (6),
the formed-on part (4) extends away from the impact edge (6) under the glass cover (2),
the formed-on part (4) contains a seal (16) adjoining the impact edge (6) to seal the impact area between the two glass covers (2, 3),
the seal (16) extends from an upper side wall (10) of the formed-on part (4) in the direction of a glass cover underside and constitutes at the top a bearing wall (21) for the second glass cover (3),
furthermore at least one support (35) is provided for the second glass cover (3),
the seal (16) rests on the support (35) on the supporting wall (21) cut free from the body of the seal in such manner that an intermediate layer is constituted between the second glass cover (3) and the support (35).

2. Glass roof according to claim 1, characterized in that the formed-on part (4) and the support (35) are formed in one piece.

3. Glass roof according to claim 1 or 2, characterized in that the formed-on part (4) and the bearing (35) are foamed, and are formed from polymer foam.

4. Glass roof according to one of the preceding claims, characterized in that the supports (35) are formed on both sides adjacent to one of the gutters (8) created by the formation (4), wherein the gutter (8) or the gutter creating formed-on part (4) is recessed in the region of the support (35).

5. Glass roof according to one of the preceding claims, characterized in that the second glass cover (3) in the region of the impact edge (27) has a lower-sided, protruding nose (30) for support on the supporting wall (21), which extends along the length of the impact edge (27) in the region of the subjacent gutter (8).

6. Glass roof according to one of the preceding claims, characterized in that the seal (16) in the region of the gutter (8) is formed with a hollow chamber (20) as a hollow-chamber seal beneath the bearing surface (21), which bounds it from above; the support (35) being so formed and arranged that the bearing surface (39) in the region of the sealing hollow chamber (20) is arranged in such a manner, so that the bearing surface (39) is positioned at the level of the inner side the seal supporting wall, and, in order to cover the support (35) from the upper side, the seal (16) in the region of the hollow chamber (20) is recessed or cut free in such a manner that, in the region of the support (35), the supporting wall (21) spans the bearing surface (39).

7. Glass roof according to one of the preceding claims, characterized in that in the region of either the support (35) or the cut-free seal (16) the underside (30) of the foam cladding (25) of the second glass cover (3) and the impact edge (27) of the second glass cover (3) enclose an essentially right angle, so that in this region a level base is formed on the support (35) or on the supporting wall (21).

8. Glass roof according to one of the preceding claims, characterized in that a second seal (17) is present, parallel to the seal (16), is located opposite the seal (16) with respect to the gutter (8), and which extends along the gutter (8).

9. Glass roof according to one of the preceding claims, characterized in that the supports (35) are formed in the region of the gutter (8).

10. Glass roof according to one of the preceding claims, characterized in that the seal (16) or the seals (16, 17) are mounted in grooves (11, 12) or are fastened to the gutter (8) and/or to the impact edges by bonding.
